(19) United States
(12) Patent Application Publication
(10) Pub. No.: US 2010/0236370 A1
(43) Pub. Date: Sep. 23, 2010

(54) CUTTING AID FOR A MOTORIZED SAW

(76) Inventor: Charles B. Hassenboehler, JR., Knoxville, TN (US)

Correspondence Address: LUEDEKA, NEELY & GRAHAM, P.C., P O BOX 1871, KNOXVILLE, TN, 37901, US

(21) Appl. No.: 12/407,832

(22) Filed: Mar. 20, 2009

(51) Int. Cl. B26D 7/00; B26D 1/12

(52) U.S. Cl. 83/478; 83/520; 83/663

(57) ABSTRACT

A motorized saw including a specially designed shoe for performing more precise cuts without the necessity of making line marks on a target object is disclosed. The motorized saw may be in different forms including a rotary saw and a reciprocal saw. A motorized rotary saw modification member is also disclosed which includes a substantially planar base for attachment to the shoe of a rotary saw. The base further includes an aperture through which a blade may extend, a primary engagement surface for engaging an object to be cut, a leading edge, a plurality of fastening members for removably attaching the modification member to the shoe of a rotary saw, and a first detent interrupting the primary engagement surface, oriented at an angle ranging from about 0 degrees to about 60 degrees relative to the leading edge.

### TECHNICAL FIELD

The disclosure relates to the field of cutting apparatuses and accessories therefor and in particular to aids for improving the use of handheld cutting devices.

### BACKGROUND AND SUMMARY

Handheld, motorized cutting tools have greatly enhanced the building industry by providing an ability to quickly cut an object such as wood to a desired length. However, obtaining an accurate orthogonal or angled cut across an object relative to a lengthwise direction of the object while keeping the cut moving in a straight line has been difficult without first pre-marking the object with a reference line. Marking the object requires additional steps and tools that may not always be readily available to the use or convenient for the user to use.

For example, a user may have the object to be cut and the motorized cutting tool ready to cut the object, but before cutting the user has to locate a marking tool and a tool such as a square to inscribe or mark a line of a desired angle across the object. Accordingly, in order to avoid multiple steps for preparing to cut an object and possible misplacement of tools necessary to mark the object, it would be beneficial to have a handheld motorized cutting tool that includes components that assist in making the desired cuts without the need for additional tools that can be misplaced, lost, or otherwise readily available to the user. While edge guides and other devices may be attached to handheld motorized cutting tools, these devices are not suitable for guiding the cutting tool when the object to be cut has a cutting plane that is too far from a guiding edge to use the guide to maintain a precise cut.

Accordingly, what is needed is a cutting aid that simplifies blade path and angular directional alignment of the cutting tool and enables a user to quickly align and maintain a substantially linear cutting plane across a width of an elongated object to be cut.

The above and other needs may be met by a motorized saw apparatus including a motor; a blade movably engaged with the motor, the blade defining a cutting plane; and a shoe attached adjacent the motor, the shoe including an aperture through which the blade extends, a primary engagement surface for engaging an object to be cut, and a first groove interrupting the primary engagement surface, the first groove oriented substantially orthogonal to the cutting plane of the blade, extending from a first edge of the shoe to a second edge of the shoe, and configured for engaging an elongate edge of said object to be cut by the motorized saw, thereby assisting in providing a cut substantially orthogonal to said elongate edge of said object when the motorized saw is rotated about the first groove to begin cutting said object. In a preferred embodiment, the first groove has a width ranging from about 4 mm to about 40 mm and a depth ranging from about 3 mm to about 40 mm. In one embodiment, the first groove has a triangular cross-sectional configuration. In a related embodiment the first groove has a rectangular cross-sectional configuration.

The motorized saw may include, for example, a rotary saw or a reciprocating saw. One embodiment including a rotary saw further includes a second groove interrupting the primary engagement surface, the second groove extending from a first edge of the shoe to a second edge of the shoe, and configured for engaging an elongate edge of an object to be cut by the motorized saw, thereby assisting in providing a cut substantially orthogonal to an upper surface of said object when the motorized saw is rotated about the second groove to begin cutting said object. A specific embodiment includes a shoe configuration wherein the first groove is located along the shoe at a first position relative to the blade and wherein the second groove is oriented substantially orthogonal to the cutting plane of the blade and located along the shoe at a second position relative to the blade and spaced-apart from the first position so that the first and second grooves are adjacent to opposite ends of the shoe.

In a preferred embodiment, the rotary saw version includes a guide means for assisting a user in maintaining the directional alignment of a cut once cutting has begun using the rotary saw. In one particular embodiment the guide means includes an axle, a first non-slip wheel fixedly attached adjacent a proximal end of the axle, and a second non-slip wheel fixedly attached adjacent a distal end of the axle, the axle being rotatably attached to the shoe in an orientation orthogonal to the cutting plane of the blade, whereby the guide means helps to maintain the direction of a cut made by the motorized saw in the object. In a related embodiment, the guide means includes a light emitting apparatus attached adjacent the blade, the light emitting apparatus for projecting a light beam along a desired cutting path superimposed substantially along the cutting plane. A specific embodiment including the light emitting apparatus further includes an optical diversion structure for diverting at least a portion of the light beam from the light emitting apparatus along a desired reference path, wherein the reference path is oriented at an angle relative to the desired cutting path, the angle ranging from about 0 degrees to about 175 degrees. In yet another related embodiment, the guide means includes a blade plane indicator extending from a front edge of a blade guard such that the blade indicator is oriented along the cutting plane of the blade.

In another embodiment, the rotary saw version includes a detent oriented at an angle ranging from about 0 degrees to about 60 degrees relative to the orientation of the first groove, the detent configured for engaging an elongate edge of said object to be cut by the motorized saw, thereby assisting in providing an angled cut relative to said elongate edge of said object when the motorized saw is rotated about the detent to begin cutting said object.

The rotary saw version may also include a movable blade guard and a grasping system for temporarily holding the blade guard at least partially in a non-guarding position to begin cutting said object, the grasping system including a first groove actuator located along the first groove, a cutting actuator to initiate blade operation, a grasping member including at least one movable engagement member, the grasping member for receiving and holding the blade guard in the at least a partial non-guarding position, and circuit logic in control communication with the first groove actuator.

In another aspect, embodiments of the disclosure provide a motorized saw apparatus comprising a motor, a blade movably engaged with the motor defining a cutting plane, and a shoe attached adjacent the motor, the shoe including an aperture through which the blade extends and a detent oriented at an angle ranging from about 90 degrees to about 150 degrees relative to the cutting plane and located near a first interface point defined by a location substantially where the blade and an object to be cut first meet, the detent configured for temporarily aligning an elongate edge of said object to be cut by the motorized saw, thereby assisting in providing a cut at an angle relative to said elongate edge of said object when the motorized saw is rotated about the detent to begin cutting said object. In a preferred embodiment, the first detent is movable, the movable detent including a first end, a second end, a fastener adjacent the first end, and a pivot point at or near the second end, wherein the movable detent may be rotated about the pivot point to a desired location at a desired angle relative to said elongate edge of said object and immobilized by the fastener so that the movable detent will remain in the desired location prior to and during cutting. In yet another embodiment, the motorized saw further includes a path alignment aperture located along the shoe in an area where the blade is oriented so that a user may see the portion of the upper surface of said object where cutting is imminent whereby the user may alter the lateral position of the motorized saw as needed based on what is seen through the path alignment aperture.

In another aspect, embodiments of the disclosure provide a rotary saw modification member configured for attachment to a shoe of a rotary saw, the modification member including a substantially planar shaped base member, the base member including an aperture through which a blade of a rotary saw may extend, a primary engagement surface for engaging an object to be cut, a leading edge, a plurality of fastening members for removably attaching the modification member to the shoe of a rotary saw, and a first detent interrupting the primary engagement surface, the first detent oriented at an angle ranging from about 0 degrees to about 60 degrees relative to the leading edge. In a related embodiment, the first detent is movable, the movable detent including a first end, a second end, a fastener adjacent the first end, and a pivot point at or near the second end, wherein the movable detent may be rotated about the pivot point to a desired location at a desired angle relative to said elongate edge of said object and immobilized by the fastener so that the movable detent will remain in the desired location prior to and during cutting. In another embodiment, the first detent includes a groove.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 shows a side perspective and partially schematic view of a motorized rotary saw apparatus including a specially designed shoe to aid a user when cutting;

FIG. 2 shows a bottom perspective and partially schematic view of the motorized saw apparatus of FIG. 1;

FIG. 3 shows a partial perspective and partially schematic view of the motorized saw apparatus of FIG. 1;

FIG. 4 shows a side and partially schematic view of the motorized saw apparatus of FIG. 1 in a frontal cutting position relative to an object to be cut;

FIG. 5 shows a side perspective and partially schematic view of the motorized saw apparatus of FIG. 1 becoming aligned with an object to be cut by engaging a first groove located along the shoe of the motorized saw apparatus with an elongate edge of the object to be cut, the saw apparatus being situated in a front chop cutting position;

FIG. 6 shows a side perspective and partially schematic view similar to FIG. 5 after the motorized saw apparatus has been laterally moved along the elongate edge of the object to be cut in order to attain proper alignment between the motorized saw apparatus and a marked point at which the object is to be cut;

FIG. 7 shows partial bottom perspective and partially schematic view of the motorized saw apparatus of FIG. 1;

FIG. 8 shows a bottom perspective and partially schematic view of a motorized saw similar to the saw shown in FIGS. 1-7 but including a groove that includes a triangular cross-section;

FIG. 9 shows a side perspective and partially schematic view of a motorized reciprocal saw apparatus including a specially designed shoe to aid a user when cutting;

FIG. 10 shows a front perspective and partially schematic view of the motorized saw apparatus of FIG. 9;

FIG. 11 shows a bottom perspective and partially schematic view of a motorized rotary saw apparatus including a specially designed shoe to aid a user when cutting, the shoe including grooves located near opposite ends of the shoe;

FIG. 12 shows a side and partially schematic view of a motorized saw apparatus including a specially designed shoe to aid a user when cutting and a grasping system for temporarily holding a blade guard to allow chop cutting;

FIG. 13 shows a side perspective and partially schematic view of an exemplary embodiment of the motorized saw shown in FIG. 12;

FIG. 14 shows a front and partially schematic view of the saw apparatus shown in FIG. 13;

FIG. 15 shows a bottom perspective and partially schematic side view of a motorized rotary saw apparatus including a specially designed shoe to aid a user when cutting, the shoe including an angled detent;

FIG. 16 shows a bottom plan view and partially schematic view of a motorized rotary saw apparatus including a specially designed shoe to aid a user when cutting, the shoe including a protruding detent;

FIG. 17 shows a side and partially schematic view of the motorized saw apparatus shown in FIG. 16;

FIG. 18 shows a bottom and partially schematic view of a motorized rotary saw apparatus including a specially designed shoe to aid a user when cutting, the shoe including a movable protruding detent and two wheels extending through the shoe;

FIG. 19 shows a bottom and partially schematic view of a motorized rotary saw apparatus including a specially designed shoe to aid a user when cutting, the shoe including a movable protruding detent, two front wheels extending through the shoe, one rear wheel extending through the shoe, and an aperture through the shoe for aligning the saw apparatus;

FIG. 20 shows a side and partially schematic view of the saw apparatus shown in FIG. 19;

FIG. 21 shows a side perspective and partially schematic view of a motorized rotary saw apparatus including a specially designed shoe to aid a user when cutting, a light emitting device for projecting reference lines, and a optical diversion structure for diverting emitted light;

FIG. 22 shows a perspective and partially schematic view of a first embodiment of the optical diversion structure shown in FIG. 21;

FIG. 23 shows a perspective and partially schematic view of a second embodiment of the optical diversion structure shown in FIG. 21;

FIG. 24 shows a perspective and partially schematic view of a motorized rotary saw apparatus including a specially designed shoe to aid a user when cutting and a removable and rotatable light emitting device for projecting reference lines, the light emitting device being positioned in a first position;

FIG. 25 shows a perspective and partially schematic view of the motorized rotary saw apparatus shown in FIG. 24 wherein the light emitting device is positioned in a second position;

FIG. 26 shows a perspective and partially schematic view of a saw attachment structure configured to attach to the shoe of a saw and aid a user when cutting; and

FIG. 27 shows a perspective and partially schematic view of the saw attachment structure shown in FIG. 26 having been attached to the shoe of a motorized rotary saw.

### DETAILED DESCRIPTION

Various terms used herein are intended to have particular meanings. Some of these terms are defined below for the purpose of clarity. The meanings of other terms used herein will be apparent from the description and drawings. The definitions given below are meant to cover all forms of the words being defined (e.g., singular, plural, present tense, past tense).
Detent: any feature that temporarily keeps a first object in a certain position relative to that of another object.
Groove: an open, channel-like feature.
Motorized: an adjective used to describe any device powered by air, steam, fuel, or electricity.
Rotate About: to maneuver a first object relative a second object in a rotational motion along a substantially fixed rotational axis, wherein the occurrence of rotational motion is at least 0.5 degrees.
Sole: an object for removable attachment to the under surface of a motorized saw shoe.

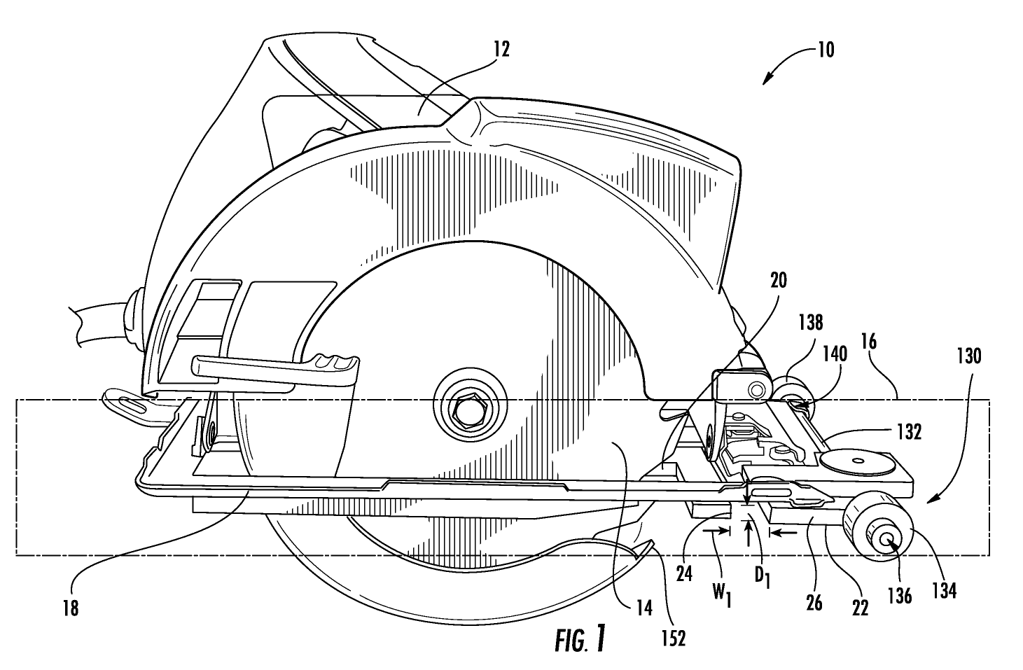

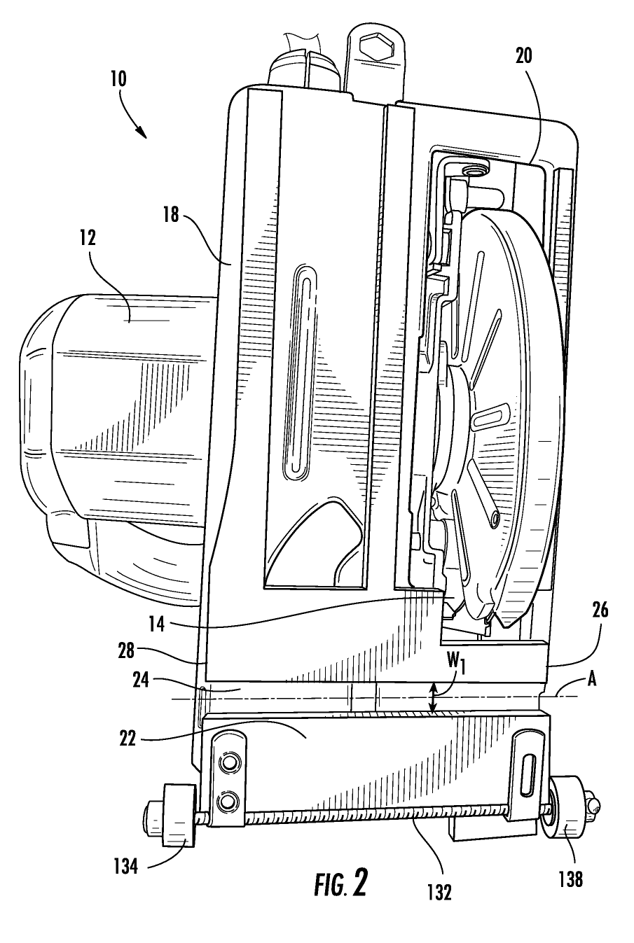

FIGS. 1-7 show a first embodiment of a motorized saw 10 including a motor 12, a blade 14 defining a cutting plane 16, and a shoe 18 for holding the blade 14 of the motorized saw 10 in a predetermined relationship to an object to be cut. The motorized saw 10 in FIGS. 1-7 is illustrated as a rotary electric saw, but other types of motorized saws are contemplated by the disclosure. In the embodiment shown in FIGS. 1-7, the blade 14 is rotatably engaged with the motor 12 and removably attached adjacent thereto. The shoe 18 is attached adjacent the motor 12, the shoe 18 including an aperture 20 through which the blade 14 extends, a primary engagement surface 22 for engaging a surface of an object to be cut, and a first groove 24 interrupting the primary engagement surface 22.

The first groove 24 in the shoe 18 is oriented substantially orthogonal to the cutting plane 16 and extends from a first edge 26 of the shoe 18 to a second edge 28 of the shoe 18. The first groove 24 is configured for engaging an elongate edge of an object to be cut by the motorized saw 10. After the first groove 24 is engaged with the elongate edge of the object to be cut, the motorized saw 10 may then be rotated about an imaginary axis “A” oriented along the first groove 24. As the motorized saw 10 rotates about axis A, the blade 14 may be activated so as to cut the object (e.g., a 2×4 piece of wood). The first groove 24 thereby assists the motorized saw 10 in providing a cut substantially orthogonal to the elongate edge of the object. In a preferred embodiment, the first groove 24 has an average width “W1” ranging from about 3 mm to about 40 mm and an average depth “D1” ranging from about 3 mm to about 40 mm. In another embodiment, the first groove 24 has an average width “W1” ranging from about 4 to about 20 mm and an average depth “D1” ranging from about 3 to about 15 mm.

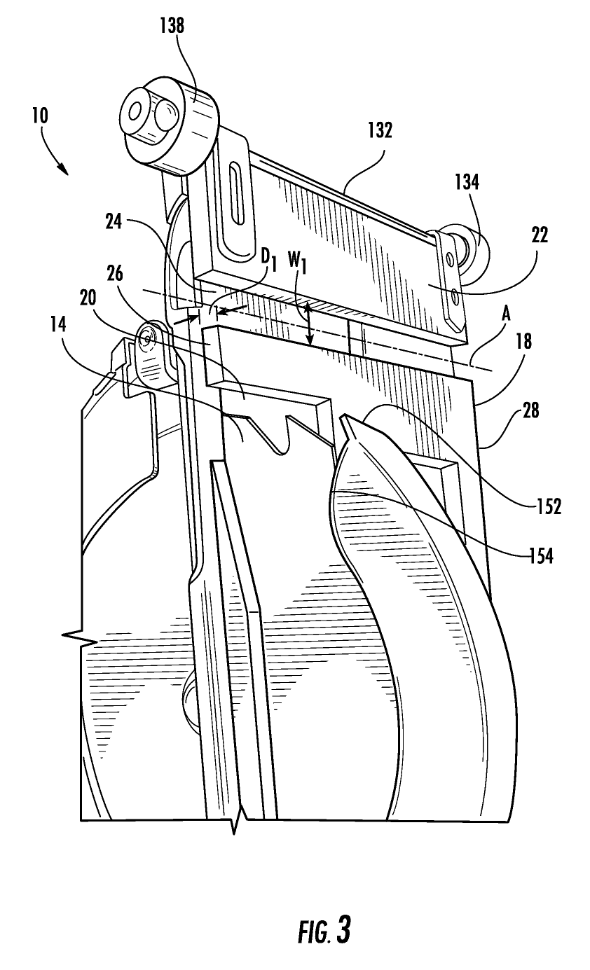

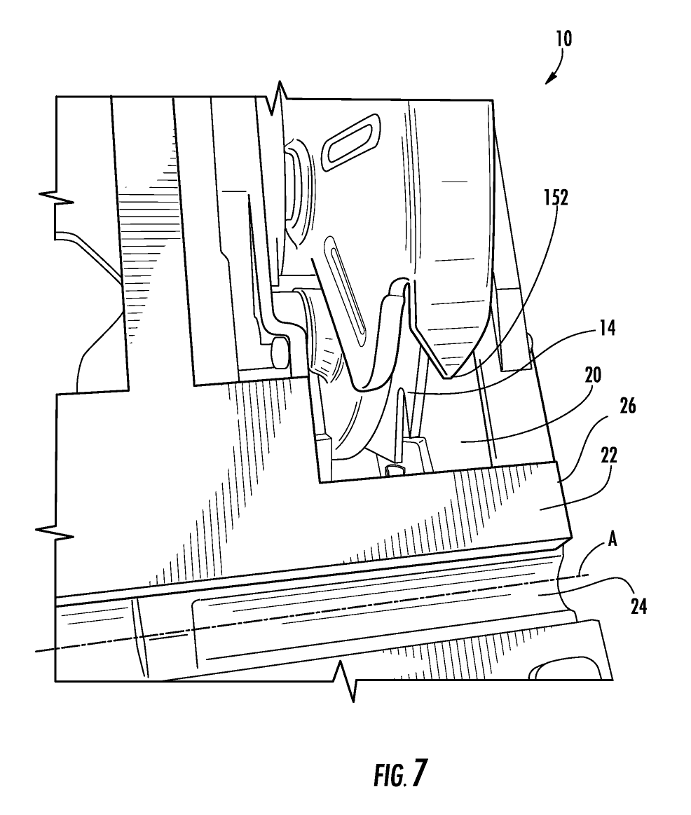

In one embodiment, the first groove 24 includes a rectangular cross-sectional configuration as shown clearly in FIG. 3. In a related embodiment, a first groove 25 includes a triangular cross-sectional configuration as shown in FIG. 8. Although two versions of cross-sectional shapes are discussed here, various cross-sectional shapes with multiple and/or curved edge(s) are contemplated. The groove 24 or 25 may be provided by stamping or otherwise molding the shoe 18 to include the groove (24 or 25) or by attaching a separate structure to the shoe 18 to provide the groove (24 or 25).

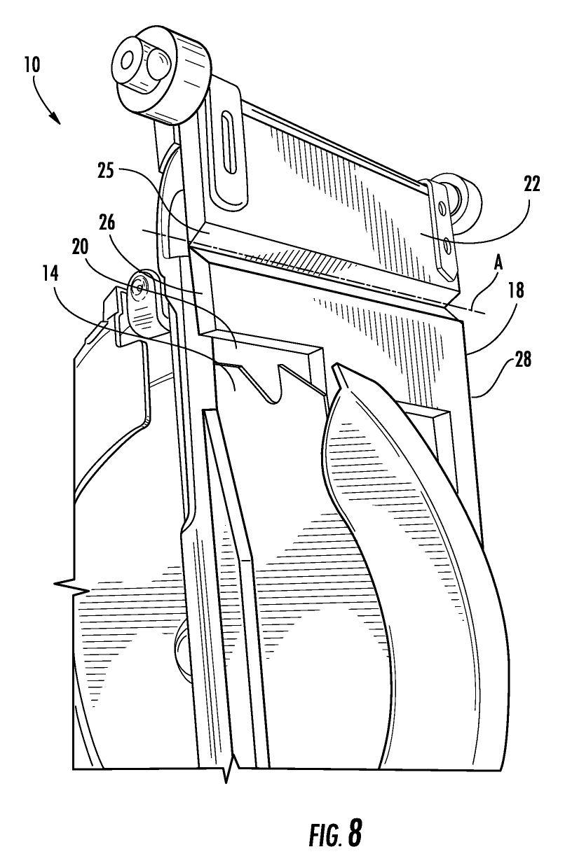

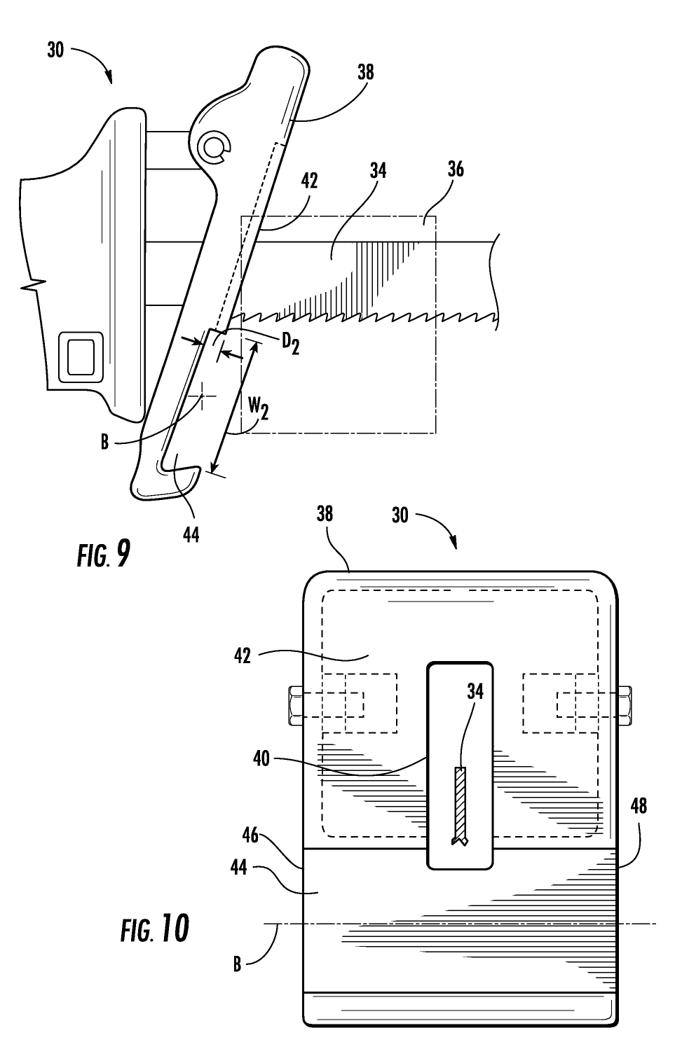

FIGS. 9-10 show a second embodiment of a motorized saw including a reciprocating motorized saw 30. The reciprocating motorized saw 30 further includes a motor (not shown) capable of producing a reciprocating motion, a blade 34 defining a cutting plane 36, and a shoe 38. The blade 34 is removably engaged with the motor and removably attached adjacent thereto. The shoe 38 is attached adjacent the motor, the shoe 38 including an aperture 40 through which the blade extends, a primary engagement surface 42 for engaging an object to be cut, and a first groove 44 interrupting the primary engagement surface 42.

The first groove 44 is oriented substantially orthogonal to the cutting plane 36 and extends from a first edge 46 of the shoe 38 to a second edge 48 of the shoe 38. The first groove 44 is configured for engaging an elongate surface or edge of an object to be cut by the motorized saw 30. After the first groove 44 is engaged with the elongate edge of the object to be cut, the motorized saw 30 may then be rotated about an imaginary axis “B” oriented along the first groove 44. As the motorized saw 30 rotates about axis B, the blade 34 may be activated so as to cut the object (e.g., PVC or aluminum conduit having an elongated edge). The first groove 44 thereby assists the motorized saw 30 in providing a cut substantially orthogonal to the elongate edge of the object. In a preferred embodiment, the first groove 44 has an average width “W2” ranging from about 10 mm to about 40 mm and an average depth “D2” ranging from about 3 mm to about 10 mm. In another embodiment, the first groove 44 has an average width “W2” ranging from about 4 to about 20 mm and an average depth “D2” ranging from about 3 to about 15 mm.

In one embodiment, the first groove 44 includes a triangular cross-sectional configuration. In a related embodiment, the first groove 44 includes a rectangular cross-sectional configuration. As with the embodiments described above regarding a rotary saw, various cross-sectional shapes with multiple and/or curved edge(s) are also contemplated with regard to embodiments regarding a reciprocating saw.

With reference back to the first embodiment of the motorized saw 10, a modified third embodiment of a motorized rotary saw 50 is shown in FIG. 11. The motorized rotary saw 50 includes a first groove 52 and a second groove 54 interrupting a primary engagement surface 56 of a shoe 58, both the first groove 52 and the second groove 54 extending from a first edge 60 of the shoe 58 to a second edge 62 of the shoe 58. The first groove 52 and the second groove 54 are each configured for engaging an elongate edge of an object to be cut by the motorized saw 50. For example, after the second groove 54 is engaged with the elongate edge of the object to be cut, the motorized saw 50 may then be rotated about an imaginary axis “C” oriented along the second groove 54. As the motorized saw 50 rotates about axis C, the blade 14 may be activated so as to cut the object. The second groove 54 thereby assists the motorized saw 50 in providing a cut substantially orthogonal to the elongate edge of the object. In a preferred embodiment, the second groove 54 has an average width “W3” ranging from about 4 mm to about 40 mm and an average depth “D3” ranging from about 3 mm to about 40 mm. In one embodiment, the first groove 52 includes a rectangular cross-sectional configuration as shown, for example, in FIG. 3 and the second groove 54 includes a triangular cross-sectional configuration as shown, for example, in FIG. 8.

Preferably, as shown in FIG. 11, the first groove 52 is located adjacent a first position 68 relative to the blade 14, and the second groove 54 is located adjacent a second position 70 relative to the blade 14 such that the second position 70 is spaced apart from the first position 68 in a manner in which the first groove 52 is adjacent to a first end 72 of the shoe 58 and the second groove 54 is adjacent to a second end 74 of the shoe 58.

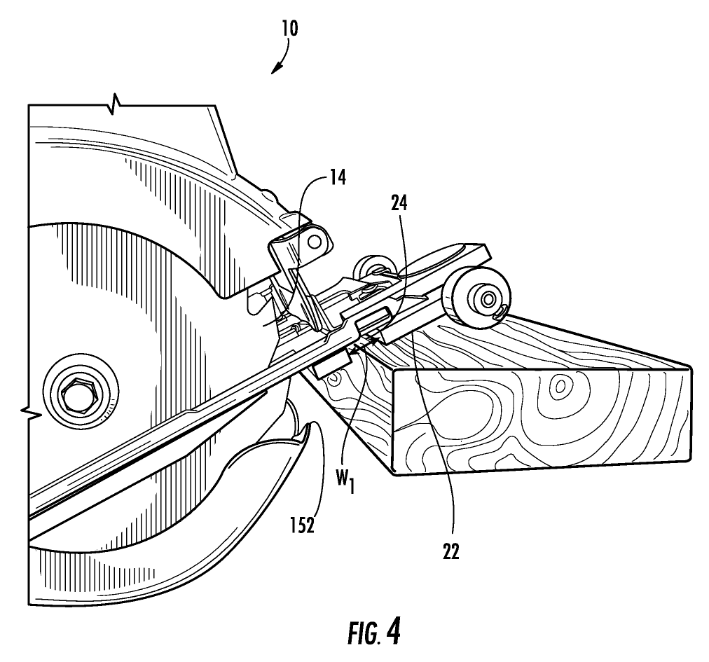

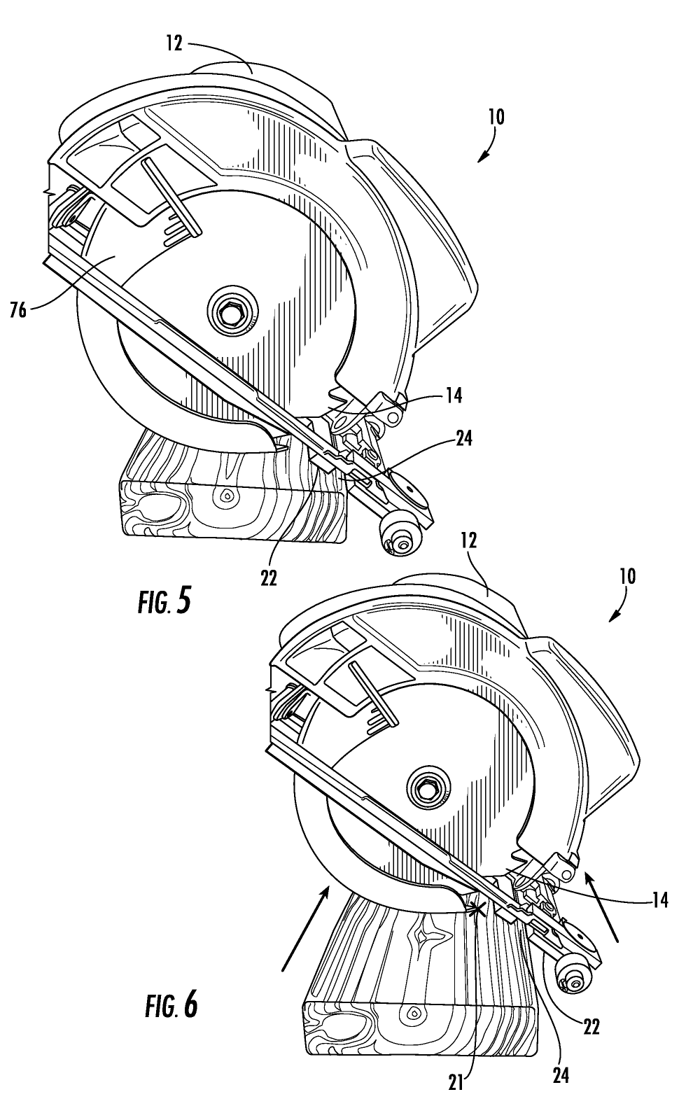

The first and third embodiments of the rotary saw described above allow a user to rotate the saw in a forward direction to initiate a substantially orthogonal cut across an object as shown in FIG. 4. During progressing rotation of the blade 14, the wheels (134, 138) contact the object to be cut and the elongate edge escapes the groove confinement and allows the saw to be rolled forward with the blade cutting through object to be cut. Beveled orthogonal cuts can also be made in this manner. Alternatively, the saw may be rotated rearward to initiate a substantially vertical cut (a “chop” cut with no bevel) through an object as shown in FIGS. 5-6.

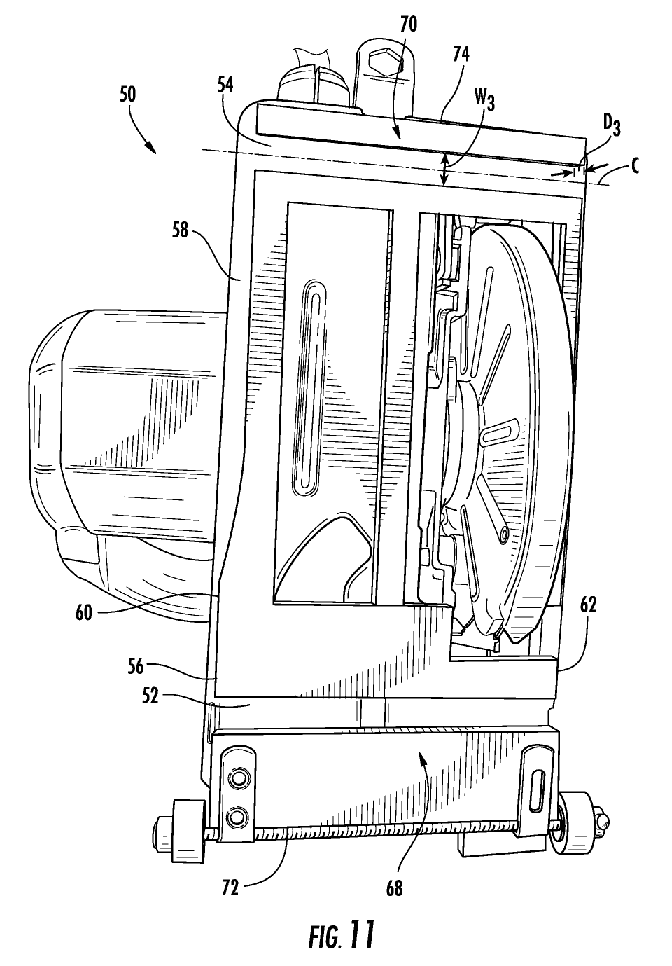

The motorized saw 10 shown in FIGS. 5-6 includes a movable blade guard 76 that must be at least partially moved prior to performing a chop cut. To this end, the saw 10 includes a blade guard grasping system 78 as shown in FIG. 12, the grasping system 78 including a first groove actuator 80 located along the first groove 24, a motor actuator 82 to initiate blade operation (e.g., a trigger), an engagement member 84, and circuit logic 88 in control communication with the first groove actuator 80 and preferably the motor actuator 82. More specifically, the circuit logic 88 is, for example, hard-wired to the various parts of the grasping system 78. In other embodiments, the control logic 88 may be in wireless control communication (e.g., infra-red, high frequency radio wave, and other types of electromagnetic communication) with the various parts of the grasping system 78 by way of a transmitter and one or more receivers. The grasping system 78 is used to temporarily hold the blade guard 76 at least partially in a non-guarding position so that an object may be cut with the motorized saw 10 using a chop cutting motion.

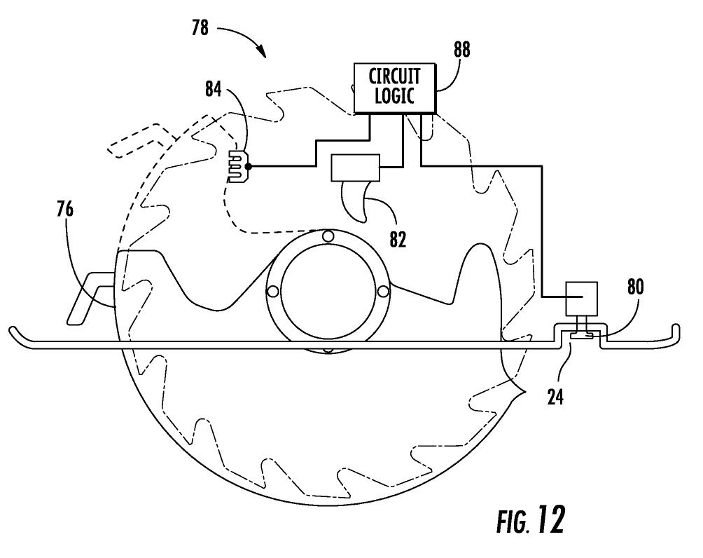

In one embodiment, the grasping system 78 is configured such that a user may manually move the blade guard 76 such that the blade guard 76 becomes engaged with the engagement member 84. More specifically, as shown in FIGS. 13-14 for example, the engagement member 84 may become actuated (in the direction of the arrow “Y”) to engage with an aperture 90 along the blade guard 76 such that the engagement member 84 remains engaged with the aperture 90 until the first groove actuator 80 becomes disengaged. More preferably, the engagement member 84 remains engaged with the aperture 90 until the first groove actuator 80 and the motor actuator 82 become disengaged. When the engagement member 84 becomes disengaged with the blade guard 76, the engagement member 84 reverses direction (in the direction of the arrow “Z”). In one embodiment, the engagement member 84 may be threaded or partially threaded like a screw so that the engagement member 84 may be partially driven through the aperture 90 by an actuator 86 that includes a corresponding threaded driving member. Other means for actuating the grasping system 78 such as a solenoid are known to persons having ordinary skill in the art, and such means are contemplated by this disclosure.

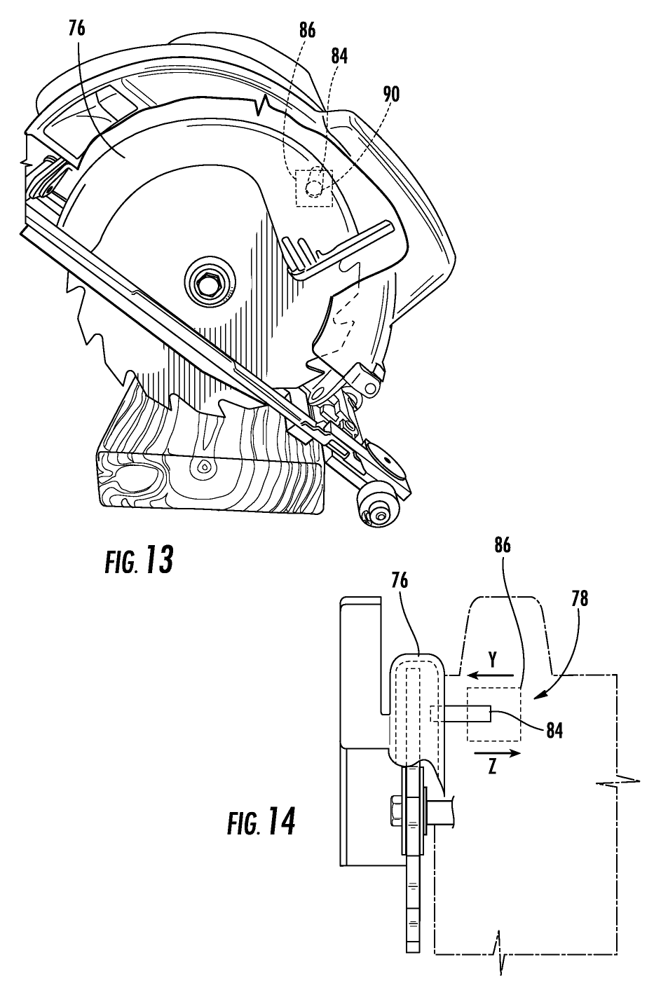

A modified fourth embodiment of a motorized rotary saw 92 is shown in FIG. 15 including the motor 12, the blade 14 defining the cutting plane 16, a shoe 94 attached adjacent the motor 12, and a first detent 96 oriented at an angle ranging from about 0 degrees to about 60 degrees relative to the orientation of a second detent 98. The first detent 96 is configured for engaging an elongate edge of an object to be cut by the motorized saw 92, thereby assisting in providing a specifically angled cut relative to the elongate edge of the object when the motorized saw 92 is rotated about the first detent 96 to begin cutting the object. The first detent 96 and the second detent 98 are distinguishable from “grooves” as defined herein in that the detents (96, 98) are more broadly defined as any feature that temporarily keeps a first object in a certain position relative to that of another object. In the fourth embodiment shown in FIG. 15, for example, the first detent 96 is in the form of a fixed groove-like structure at an angle of about 45 degrees. The embodiment of the rotary saw 92 in FIG. 15 also includes the second detent 98 oriented orthogonal to the cutting plane 16 of the blade 14. The second detent 98 is located adjacent a first groove 100 oriented substantially parallel to the second detent 98. Grooves such as the first groove 100 in FIG. 15 tend to be more useful for chop cuts and/or short cuts whereas detents such as the first detent 96 and the second detent 98 tend to be more useful for extended cuts across objects.

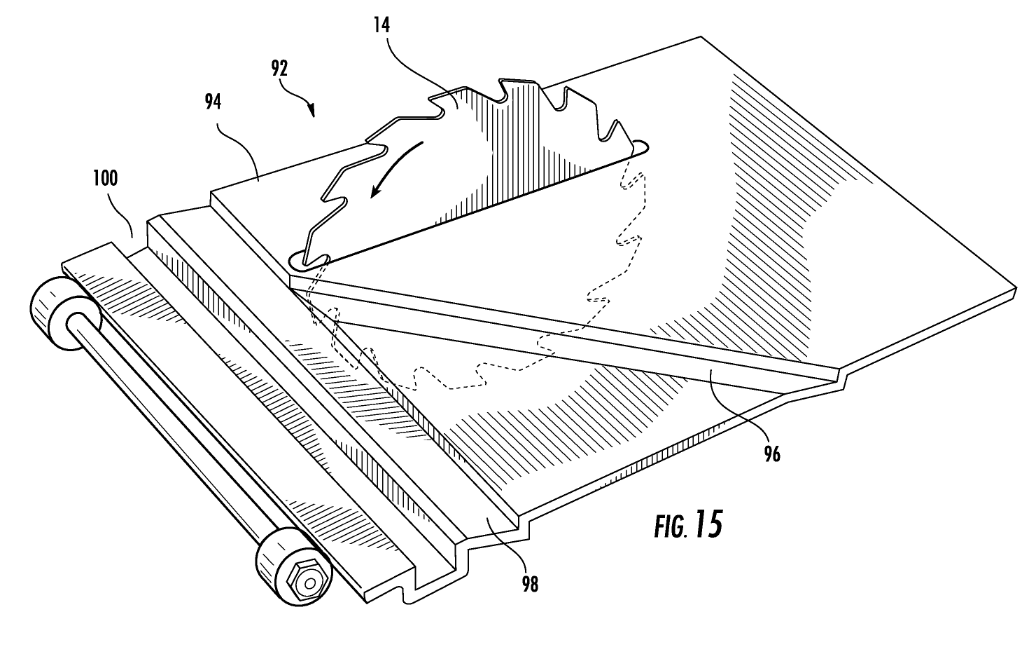

A fifth embodiment of a motorized rotary saw 102 shown in FIGS. 16-17 includes a protruding detent 104. The motorized saw 102 in FIGS. 16-17 does not include a fixed groove, however. Rather, the detent 104 extends outward from a bottom surface 106 of a shoe 108 to assist a user in initially aligning an elongate edge of an object to be cut at a desired angle relative to the cutting plane 16 of the blade 14. The detent 104 is oriented at an angle ranging from about 90 degrees to about 150 degrees relative to the cutting plane 16. The detent 104 is located near a first interface point 110 defined by the location at or near where the blade 14 and the object being cut initially make contact. In order to help balance the contact between the motorized saw 102 and an object being cut, the saw 102 further includes one or more shoe spacers 112. The detent 104 of the rotary saw 102 shown in FIGS. 16-17 is movable; however other embodiments may include a stationary detent(s).

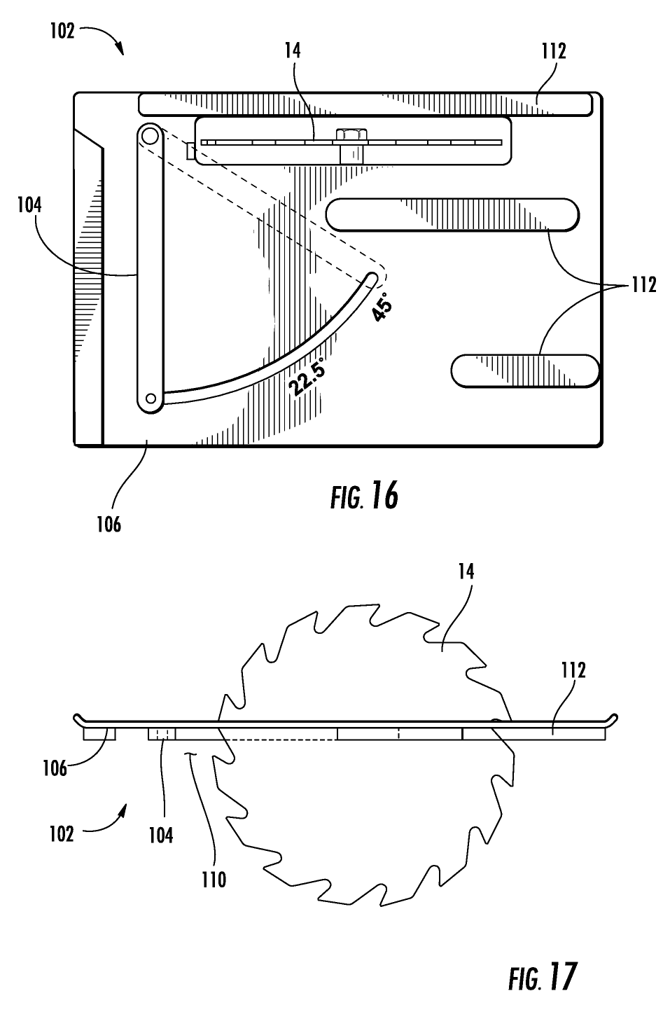

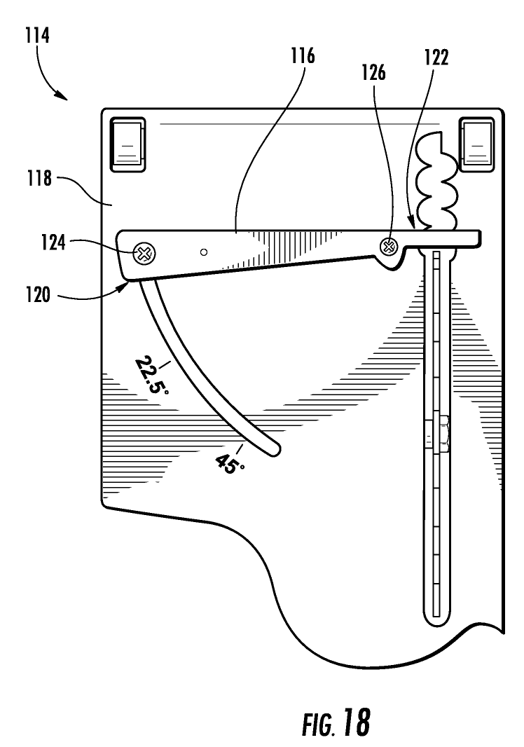

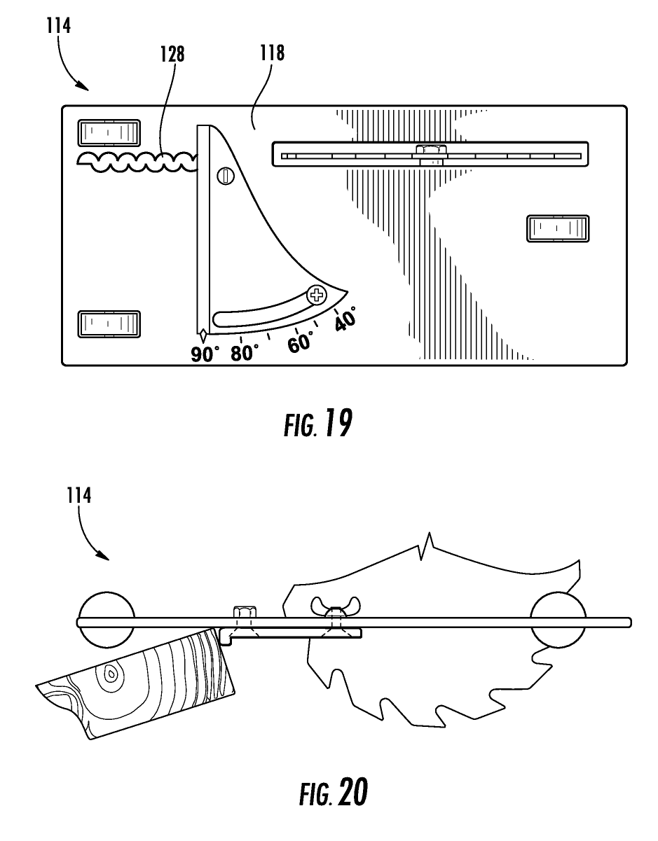

In a related embodiment shown in FIG. 18, a motorized rotary saw 114 further includes a movable protruding detent 116 attached to a shoe 118 wherein the detent 116 includes a first end 120, a second end 122 distal to the first end 120, a fastener 124 adjacent the first end 120, and a pivot point 126 near the second end 122. The detent 116 may be rotated about the pivot point 126 to a desired location at a desired angle relative to the elongate edge of the object to be cut. The movable detent 116 may be further immobilized at the desired location by the fastener 124 so that the movable detent 116 will remain in the desired location prior to and during cutting. Any fastener known to a person having ordinary skill in the art may be used such as, for example, a screw or threaded bolt. A variation of this embodiment is shown in FIGS. 19-20. In a preferred embodiment, the motorized saw 114 further includes a path alignment aperture 128 located along the shoe 118. The path alignment aperture 128 is located in an area where the cutting plane 16 is oriented so that a user may see the portion of the upper surface of the structure where cutting is imminent. This allows the user to alter the lateral placement of the motorized saw 114 as needed based on what is seen through the path alignment aperture 128.

Various embodiments of motorized rotary saws described above may include a guide means for assisting a user in maintaining the direction of a cut once cutting has begun using the rotary saw. For example, the motorized rotary saw 10 shown in FIGS. 1-6 includes a guide means 130 including an axle 132, a first wheel 134 fixedly attached adjacent a proximal end 136 of the axle 132, a second wheel 138 fixedly attached adjacent a distal end 140 of the axle 132, wherein the axle 132 is rotatably attached to the shoe 18 in an orientation orthogonal to the cutting plane 16 of the blade 14. The wheels 134 and 138 help maintain a rolling frictional engagement between the saw 10 and the object to be cut rather than a sliding frictional engagement that can cause misalignment along the cutting plane 16. As shown in FIG. 20, the wheels 134 and 138 may provide spacing between the shoe 18 and the object being cut without the need for the shoe spacers 112 described above. Likewise one or more rear wheels 139 may be provided for similar purposes. For example, to execute a substantially orthogonal cut, the shoe 18 is placed on the object to be cut such that the wheels (134, 138) are suspended above the object to be cut and the detent (e.g., the detent 116 shown in FIG. 18) is in contact with an elongate edge of the object to be cut as shown, for example, in FIG. 20. The saw may be adjusted laterally as shown, for example, in FIGS. 5-6, so that a marked point 21 on the object to be cut is aligned in the cutting plane 36. Motorized movement of the rotary saw blade 16 is initiated and the saw is rotated about the elongate edge until the wheels (134, 138) contact the object to be cut. At this point, the detent has become free from engagement with the elongate edge of the object to be cut. The cutting procedure may then proceed by advancing (rolling) the guided saw along and through the object to be cut.

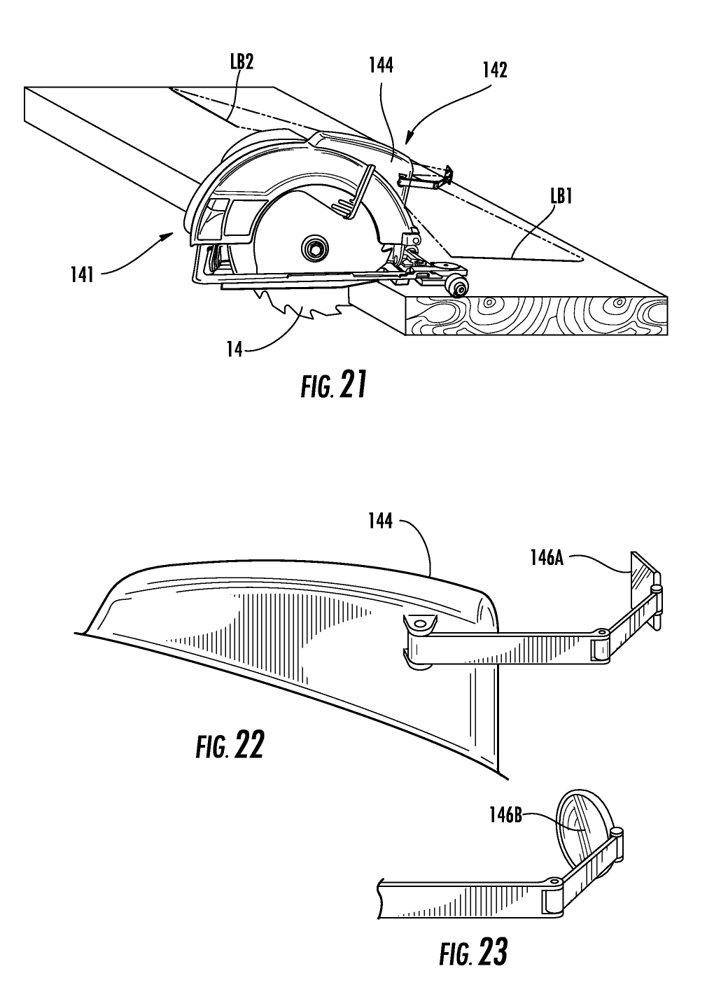

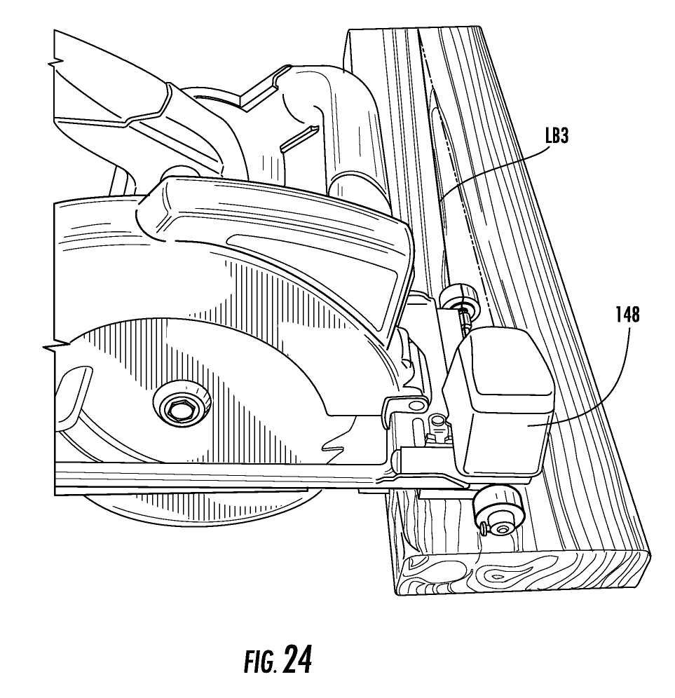

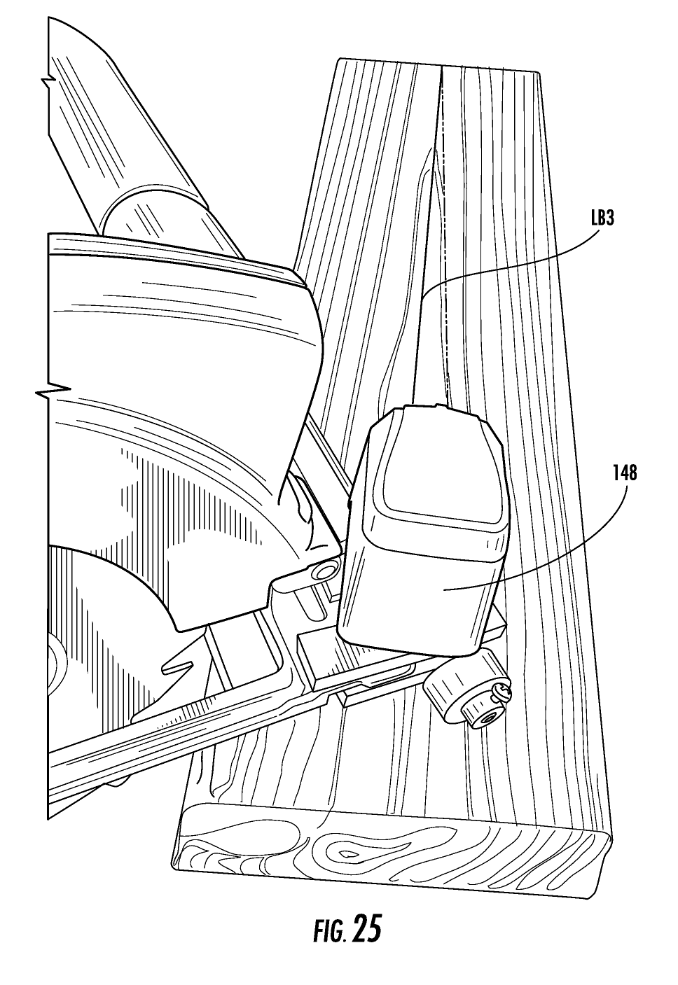

In the embodiment of a motorized rotary saw 141 shown in FIG. 21, an alternative directional guide means 142 includes a light emitting device 144 attached adjacent the blade 14 for projecting a light beam (LB1) along a desired cutting path superimposed substantially along the cutting plane 16. Preferably, as shown in FIG. 21 the motorized saw 141 further includes an optical diversion structure 146 (e.g., a movable mirror 146A [FIG. 22] or a movable lens 146B [FIG. 23] attached adjacent the motor) for diverting at least a portion of the light beam (LB2) from the light emitting device 144 along a desired reference path, wherein the reference path is oriented at an angle relative to the desired cutting path, the angle preferably ranging from about 0 degrees to about 175 degrees. In another embodiment shown in FIG. 24-25, a movable light emitting device 148 is attached adjacent the blade 14 along the cutting plane 16. The light emitting device 148 shown in FIG. 24-25 is removable from the motorized saw 10 (e.g., by using one or more magnetic fastening pieces) and is freely rotatable so that a light beam (e.g., a laser) (LB3) may be emitted at virtually any angle orthogonally relative to the cutting plane 16. The light emitting devices (144, 148) shown in FIGS. 21-25 emit light beams that are substantially planar. For example, the light emitting device 148 projects a plane of light oriented substantially orthogonal to the shoe 18 and at a desired angle relative to the cutting plane 36 as shown in FIG. 24. The saw may be laterally adjusted as in FIGS. 5-6 such that the marked point 21 is contained in the cutting plane 16. Then, the saw may be rotated along an elongate edge of the object to be cut such that the light beam (LB3) is displayed along the object to be cut in a line substantially parallel to the elongate edge of the object to be cut. Although planar beams of light are shown in FIGS. 21-25, substantially linear and other shaped light emissions are contemplated in this disclosure.

Another example of a guide means is shown in FIGS. 1, 3, 4 and 7 including a blade plane indicator 152 extending from a front edge 154 of the blade guard 76 such that the blade plane indicator 152 is oriented along the cutting plane 16.

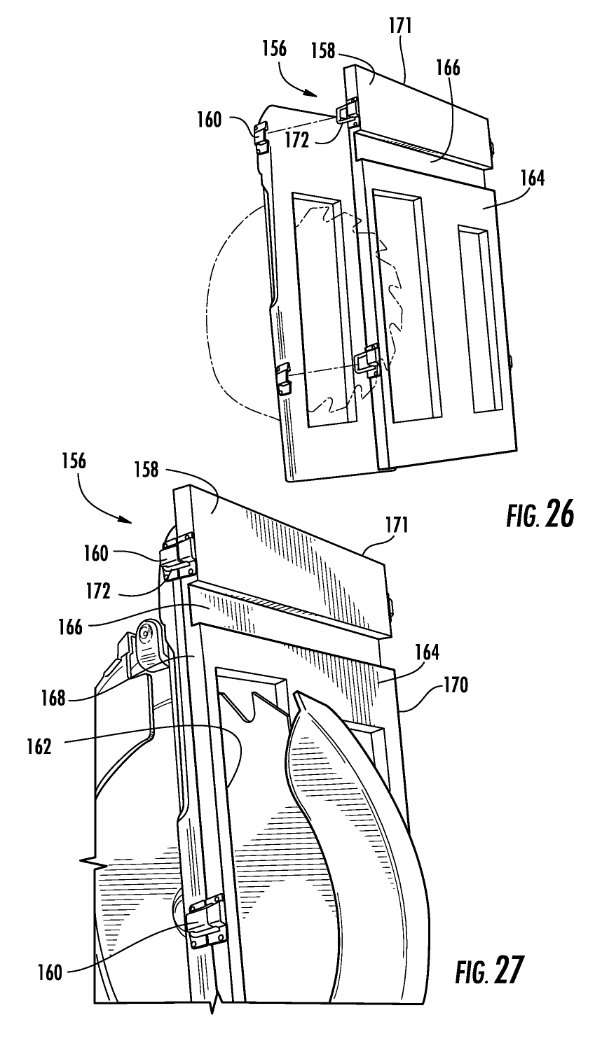

A rotary saw modification member 156 is also disclosed, the modification member 156 including a sole 158 and a fastening system 160 as shown in FIGS. 26-27. The sole 158 further includes an aperture 162 through which a saw blade may extend, a primary engagement surface 164 for engaging an object to be cut, and a first detent 166 interrupting the primary engagement surface 164. In one embodiment, the first detent 166 is oriented substantially orthogonal to the cutting plane of an engaged saw blade and extends from a first edge 168 of the shoe sole 158 to a second edge 170 of the shoe 158. In a related embodiment, the first detent 166 is oriented at an angle ranging from about 0 degrees to about 60 degrees relative to a leading edge 171 of the modification member 156. The first detent 166 is configured for engaging an elongate edge of an object to be cut by the motorized saw 10. In the embodiment shown in FIGS. 26-27, the fastening system includes a set of four latches 172 that may be locked into place to secure the saw attachment 156 to the shoe of a saw as shown in FIG. 27. In a related example, the saw attachment 156 may be retrofitted to the shoe of a prior art rotary saw using, for example, a plurality of clamps that may be tightened by, for example, screw inserts. However, any means for attaching the sole 158 to a saw shoe known to a person having ordinary skill in the art is contemplated. In a preferred embodiment, the first detent 166 is a groove. Other embodiments of saw attachments may include, for example, more than one detents or grooves, a movable detent (as described in rotary saw embodiments above), and/or a guide means.

Many of the embodiments covered by this disclosure may be used to cut a myriad of different objects including basic construction materials made of, for example, wood, metal, polymer material, rock, and/or composite material. The rotary saw embodiments may be used to perform chop cuts and/or extended cuts in which relative linear motion between the saw and the object being cut is required.

The previously described embodiments of the present disclosure have many advantages, including enhancing the accuracy of cuts made on objects at specific angles and eliminating the need to mark the entire line path where a cut is desired to be made while aligning the saw to only a single point along the cutting path. By improving the accuracy of cuts that are made, fewer resources may be wasted because fewer unacceptable cuts may be made, resulting in less discarded material. Also, by eliminating the need for a user to physically mark (e.g., by a pencil) where a cut is desired on an object, a significant amount of time may be saved, thereby increasing efficiency in situations where many successive cuts need to be made. The saw attachment embodiments allow for a saw without the inventive features described herein to be retrofitted with a saw attachment including some or all of such inventive features.

The foregoing description of preferred embodiments for the present disclosure has been presented for purposes of illustration and description. The description of preferred embodiments is not intended to be exhaustive or to limit the disclosure to the precise form disclosed. Obvious modifications or variations are possible in light of the above teachings. The embodiments are chosen and described in an effort to provide the best illustrations of the inventive principles of the disclosure and their practical application, and to thereby enable one of ordinary skill in the art to utilize the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

Any element in a claim that does not explicitly state “means for” performing a specified function, or “step for” performing a specific function, is not to be interpreted as a “means” or “step” clause as specified in 35 U.S.C. §112, ¶6. In particular, the use of “step of” in the claims herein is not intended to invoke the provisions of 35 U.S.C. §112, ¶6.

What is claimed is:

1. A motorized saw apparatus comprising:
a motor;
a blade movably engaged with the motor, the blade defining a cutting plane; and
a shoe attached adjacent the motor, the shoe including an aperture through which the blade extends, a primary engagement surface for engaging an object to be cut, and a first groove interrupting the primary engagement surface, the first groove oriented substantially orthogonal to the cutting plane of the blade, extending from a first edge of the shoe to a second edge of the shoe, and configured for engaging an elongate edge of said object to be cut by the motorized saw, thereby assisting in providing a cut substantially orthogonal to said elongate edge of said object when the motorized saw is rotated about the first groove to begin cutting said object.

2. The motorized saw of claim 1 wherein the first groove has a width ranging from about 3 mm to about 40 mm and a depth ranging from about 3 mm to about 40 mm.

3. The motorized saw of claim 2, wherein the first groove has a triangular cross-sectional configuration.

4. The motorized saw of claim 2, wherein the first groove has a rectangular cross-sectional configuration.

5. The motorized saw of claim 1 further comprising a saw selected from the group consisting of a rotary saw and a reciprocating saw.

6. The motorized saw of claim 5, further comprising a second groove interrupting the primary engagement surface, the second groove extending from a first edge of the shoe to a second edge of the shoe, and configured for engaging an elongate edge of an object to be cut by the motorized saw, thereby assisting in providing a cut substantially orthogonal to an upper surface of said object when the motorized saw is rotated about the second groove to begin cutting said object.

7. The motorized saw of claim 5 comprising a rotary saw, the rotary saw further comprising a guide means for assisting a user in maintaining a directional alignment of a cut while using the rotary saw.

8. The rotary saw of claim 6 wherein the first groove is located along the shoe at a first position relative to the blade and wherein the second groove is oriented substantially orthogonal to the cutting plane of the blade and located along the shoe at a second position relative to the blade and spaced-apart from the first position so that the first and second grooves are adjacent to opposite ends of the shoe.

9. The rotary saw of claim 1, the shoe further comprising a detent oriented at an angle ranging from about 0 degrees to about 60 degrees relative to the orientation of the first groove, the detent configured for engaging an elongate edge of said object to be cut by the motorized saw, thereby assisting in providing an angled cut relative to said elongate edge of said object when the motorized saw is rotated about the detent to begin cutting said object.

10. The motorized saw of claim 7 wherein the guide means comprises an axle, a first non-slip wheel fixedly attached adjacent a proximal end of the axle, and a second non-slip wheel fixedly attached adjacent a distal end of the axle, the axle being rotatably attached to the shoe in an orientation orthogonal to the cutting plane of the blade, whereby the guide means helps to maintain the direction of a cut made by the motorized saw in the object.

11. The motorized saw of claim 7 wherein the guide means comprises a light emitting apparatus attached adjacent the blade, the light emitting apparatus for projecting a light beam along a desired cutting path superimposed substantially along the cutting plane.

12. The motorized saw of claim 7 further comprising a movable blade guard, wherein the guide means comprises a blade indicator extending from a front edge of the blade guard such that the blade indicator is oriented along the cutting plane of the blade.

13. The motorized saw of claim 11 further comprising an optical diversion structure for diverting at least a portion of the light beam from the light emitting apparatus along a desired reference path, wherein the reference path is oriented at an angle relative to the desired cutting path, the angle ranging from about 0 degrees to about 175 degrees.

14. The motorized saw of claim 5, comprising a rotary saw, the rotary saw further comprising a movable blade guard and a grasping system for temporarily holding the blade guard at least partially in a non-guarding position to begin cutting said object, the grasping system including a first groove actuator located along the first groove, a cutting actuator to initiate blade operation, a grasping member including at least one movable engagement member, the grasping member for receiving and holding the blade guard in the at least a partial non-guarding position, and circuit logic in control communication with the first groove actuator.

15. A motorized saw apparatus comprising a motor, a blade movably engaged with the motor defining a cutting plane, and a shoe attached adjacent the motor, the shoe including an aperture through which the blade extends and a detent oriented at an angle ranging from about 90 degrees to about 150 degrees relative to the cutting plane and located near a first interface point defined by a location substantially where the blade and an object to be cut first meet, the detent configured for temporarily aligning an elongate edge of said object to be cut by the motorized saw, thereby assisting in providing a cut at an angle relative to said elongate edge of said object when the motorized saw is rotated about the detent to begin cutting said object.

16. The motorized saw of claim 15 wherein the first detent is movable, the movable detent including a first end, a second end, a fastener adjacent the first end, and a pivot point at or near the second end, wherein the movable detent may be rotated about the pivot point to a desired location at a desired angle relative to said elongate edge of said object and immobilized by the fastener so that the movable detent will remain in the desired location prior to and during cutting.

17. The motorized saw of claim 16 further comprising a path alignment aperture located along the shoe in an area where the blade is oriented so that a user may see the portion of the upper surface of said object where cutting is imminent whereby the user may alter a lateral position of the motorized saw as needed based on the user's visual observation of coincidence between the cutting plane and a marked point on the object to be cut as seen through the path alignment aperture.

18. A rotary saw modification member configured for attachment to a shoe of a rotary saw, the modification member comprising a substantially planar shaped base member, the base member including an aperture through which a blade of a rotary saw may extend, a primary engagement surface for engaging an object to be cut, a leading edge, a plurality of fastening members for removably attaching the modification member to the shoe of a rotary saw, and a first detent interrupting the primary engagement surface, the first detent oriented at an angle ranging from about 0 degrees to about 60 degrees relative to the leading edge.

19. The rotary saw modification member of claim 18 wherein the first detent is movable, the movable detent including a first end, a second end, a fastener adjacent the first end, and a pivot point at or near the second end, wherein the movable detent may be rotated about the pivot point to a desired location at a desired angle relative to said elongate edge of said object and immobilized by the fastener so that the movable detent will remain in the desired location prior to and during cutting.

20. The rotary saw modification member of claim 18 wherein the detent comprises a groove.
